(19) United States
(12) Patent Application Publication
(10) Pub. No.: US 2024/0399499 A1
(43) Pub. Date: Dec. 5, 2024

(54) LARGE FORMAT LASER PROCESSING MODULE

(71) Applicant: Taicang Manaflex Technology Co., Ltd., Taicang City (CN)

(72) Inventors: Robert C. LANE, Las Vegas, NV (US); Augusto E. BARTON, Pinecrest, FL (US); Yifei LIU, Toronto (CA)

(21) Appl. No.: 18/733,964

(22) Filed: Jun. 5, 2024

(30) Foreign Application Priority Data
Jun. 5, 2023 (CN) 202321404911.1

(51) Int. Cl. B23K 26/10; B23K 26/38

(52) U.S. Cl. CPC B23K 26/10; B23K 26/38

(57) ABSTRACT

A large-format laser processing module, comprising galvanometer cutting modules arranged above a stand through a gantry; the gantry comprises two support frames fixed to the stand and a crossbeam fixed to the top of the two support frames; a mounting plate for mounting the galvanometer cutting modules is arranged on the same side or both sides of the crossbeam; and one or more galvanometer cutting modules are arranged within the mounting plate. The large-format laser processing the number of the galvanometer cutting modules is at least two and the galvanometer cutting modules are arranged on the same side or both sides of the crossbeam; module disclosed in the present invention is characterized by a simple structure and simultaneous processing by a plurality of galvanometer cutting modules, which improves production efficiency.

### CROSS-REFERENCE TO RELATED APPLICATION

This application claims priority to and the benefit of Chinese Utility Model application No. 202321404911.1, filed Jun. 5, 2023, the entire disclosure of which is incorporated by reference in its entirety.

### TECHNICAL FIELD

The present invention relates to the technical field of coil processing, in particular to a large-format laser processing module.

### BACKGROUND TECHNOLOGY

In industrial production and processing, aiming at the processing of various kinds of cover-layer (CVL) and FPC/R-FPC (rigid-flexible printed circuit-flexible circuit board), die cutting machine (die stamping method), FPC roll-to-film equipment and FPC roll-to-roll equipment are usually used to process products with different requirements. However, with the development of science and technology, to meet the needs of enterprises, for cutting large quantities of parts or large-format parts used in batteries of new energy vehicles, raw materials should be cut to narrow widths and processed by the existing equipment, and then spliced by welding or moving the laser head in a large range. However, the maximum speed of the existing laser cutting technology is 400 mm/s, which still cannot meet the production needs and affects the production capacity.

### SUMMARY

The present invention aims to provide a large-format laser processing module to overcome the shortcomings in the prior art.

To achieve the above purpose, the present invention provides the following technical solutions:

The present invention discloses a large-format laser processing module, comprising galvanometer cutting modules arranged above a stand through a gantry; the gantry comprises two support frames fixed to the stand and a crossbeam fixed to the top of the two support frames; the number of the galvanometer cutting modules is at least two and the galvanometer cutting modules are arranged on the same side or both sides of the crossbeam; a mounting plate for mounting the galvanometer cutting modules is arranged on the same side or both sides of the crossbeam; and one or more galvanometer cutting modules are arranged within the mounting plate.

Further, in the large-format laser processing module, the mounting plate is slidably connected to one side of the crossbeam by a linear motor and a plurality of galvanometer cutting modules are arranged side by side within the mounting plate.

Further, in the large-format laser processing module, both sides of the crossbeam are slidably connected to a mounting plate by a linear motor, respectively.

Further, in the large-format laser processing module, one galvanometer cutting module is arranged within the mounting plate.

Further, in the large-format laser processing module, a plurality of galvanometer cutting modules are arranged side by side within the mounting plate.

Further, in the large-format laser processing module, a plurality of galvanometer cutting modules are arranged on both sides of the crossbeam through the mounting plate.

Further, in the large-format laser processing module, the adjacent galvanometer cutting modules on both sides of the crossbeam are staggered.

Further, the large-format laser processing module comprises an image detection system.

Compared with the prior art, the present invention has the advantage that the large-format laser processing module is characterized by a simple structure and simultaneous processing by a plurality of galvanometer cutting modules, which improves production efficiency.

### BRIEF DESCRIPTION OF THE FIGURES

To describe the technical solutions in the embodiments of the present invention more clearly, the following briefly introduces the accompanying drawings. It is clear that the drawings described below are only some embodiments of the present invention. For a person of ordinary skill in the art, other drawings can be obtained according to these drawings without creative labor. Under this premise, other drawings can be obtained based on these drawings.

FIG. 1 is a schematic diagram of a structure of a large-format laser processing module according to an embodiment of the present invention.

FIG. 2 is a schematic diagram of a structure of a large-format laser processing module according to another embodiment of the present invention.

FIG. 3 is a schematic diagram of a position of galvanometer cutting modules according to still another embodiment of the present invention.

FIG. 4 is a schematic diagram of a processing area of a large-format laser processing module according to yet another embodiment of the present invention.

### DESCRIPTION OF EMBODIMENTS

The following describes the technical solutions in embodiments of the present invention with reference to the drawings in embodiments of the present invention. It is clear that the described embodiments are merely a part rather than all of embodiments of the present invention. Based on the embodiments of the present invention, all other embodiments obtained by a person of ordinary skill in the art without making creative labor fall within the scope of protection of the present invention.

In the description of the present invention, it should be noted that the terms “center”, “upper”, “lower”, “left”, “right”, “vertical”, “horizontal”, “inside” and “outside” indicating the orientation or positional relationship are based on the orientation or positional relationship shown in the accompanying drawings, and are only for the purpose of facilitating the description of the present invention and simplifying the description. The terms shall not be understood as an indication or implication that a device or element referred to shall be constructed and operated with a particular orientation, and therefore shall not be understood as limitations on the present invention. In addition, terms such as “first”, “second” and “third” mentioned below are merely intended for a purpose of description, and shall not be understood as an indication or implication of relative importance.

In the description of the present invention, it should be noted that terms “installation”, “connecting” and “connection” should be understood in a broad sense unless otherwise expressly specified and limited. For example, the “connection” may be a fixed connection, may be a detachable connection, may be an integral connection; may be a mechanical connection, may be an electric connection; may be a direct connection, or may be an indirect connection implemented through a medium, or may be a connection inside two elements. For a person of ordinary skill in the art, the specific meaning of the above terms in the context of the present invention may be understood in specific cases.

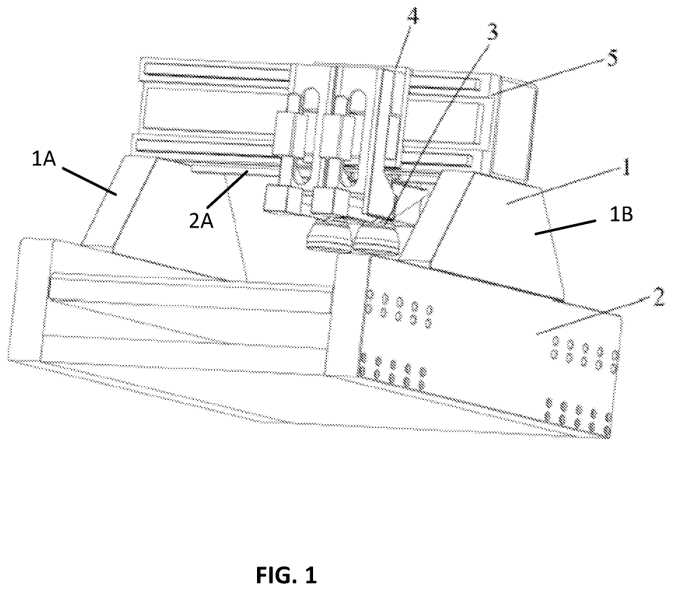

As an example, refer to FIG. 1 to FIG. 4, a large-format laser processing module, comprising galvanometer cutting modules 3 arranged above a stand 2 through a gantry 1; the gantry 1 comprises two support frames 1A and 1B fixed to the stand 2 and a crossbeam 2A fixed to the top of the two support frames 1A and 1B; the number of the galvanometer cutting modules 3 is at least two and the galvanometer cutting modules are arranged on the same side or both sides of the crossbeam 2A; a mounting plate for mounting the galvanometer cutting modules 3 is arranged on the same side or both sides of the crossbeam 2A; and one or more galvanometer cutting modules 3 are arranged within the mounting plate 4.

In the technical solution, the stand is the stand of the existing sheet processing equipment, the stand of the coil processing, or the stand of the production line, the gantry is of a conventional structure, which can be arranged according to the actual situation of the stand, and the mounting plate 4 is used for realizing the fixed installation of the galvanometer cutting modules. The structure and principle of the galvanometer cutting modules can be realized through conventional systems and will not be repeated here. The large-format laser processing module is characterized by a simple structure and simultaneous processing by a plurality of galvanometer cutting modules, which improves production efficiency.

As an example, refer to FIG. 1, the mounting plate 4 is slidably connected to one side of the crossbeam 2A by a linear motor 5, and a plurality of galvanometer cutting modules 3 are arranged side by side within the mounting plate 4.

In the technical solution, a strip start-up/stop mode is used. When the strip stops, the linear motor drives the two galvanometer cutting modules to move to the position to be processed in sequence, and the two galvanometer cutting modules process simultaneously. The processing area of the two galvanometer cutting modules can be partially overlapped. In the processing process, the corresponding splicing is completed within the area of overlapped parts. Then, it moves to the next position to be processed, which ensures the continuity of processing. The processing area of the two galvanometer cutting modules can be separately arranged and the processing and splicing can be realized by moving the linear motor. The simultaneous processing by the two galvanometer cutting modules can improve work efficiency and also reduce the distance and frequency of linear motor movement, further improving work efficiency.

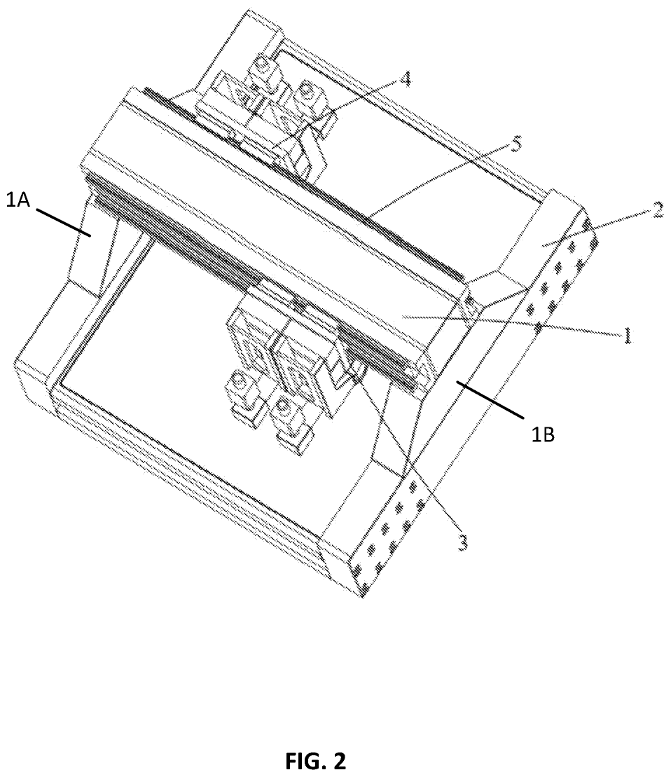

As an example, refer to FIG. 2, both sides of the crossbeam 2A are slidably connected to a mounting plate 4 by a linear motor 5, respectively.

In the technical solution, the linear motor is of a conventional structure, fixed to the crossbeam by bolts, etc. The mounting plate is fixed to the slider of the linear motor by bolts for fixing and mounting the galvanometer cutting modules.

As an example, one galvanometer cutting module 3 is arranged within the mounting plate 4.

In the technical solution, the galvanometer cutting module is slidably arranged on both sides of the crossbeam, which can complete the processing of one-half of the area in the width direction respectively, and complete the splicing of cut seams with the movement of the strip. The two galvanometer cutting modules can complete the corresponding processing simultaneously, which improves production efficiency.

As an example, refer to FIG. 2, two galvanometer cutting modules 3 are arranged side by side within the mounting plate 4.

In the technical solution, two galvanometer cutting modules are arranged on both sides of the crossbeam, respectively. As a result, four galvanometer cutting modules complete the processing simultaneously, which can complete the processing of four areas after each movement, improving production efficiency.

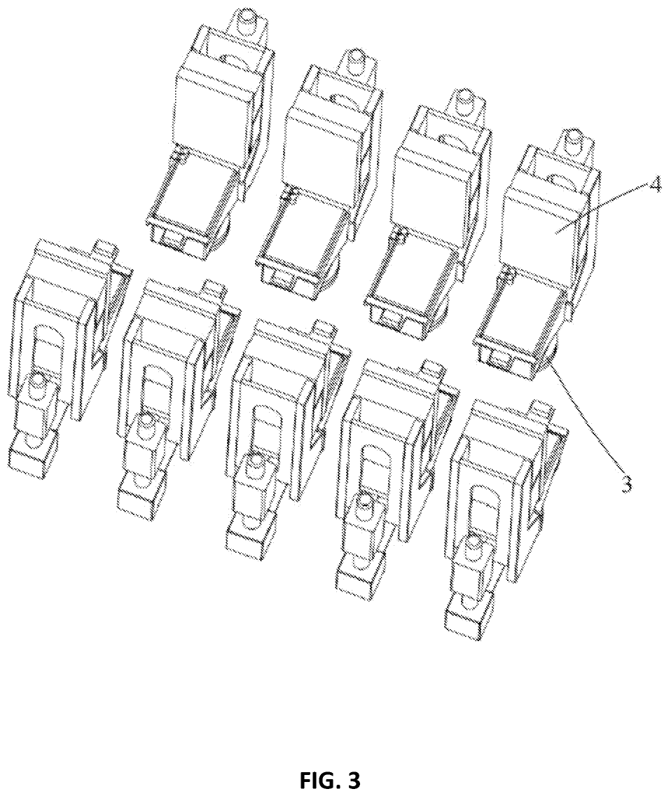

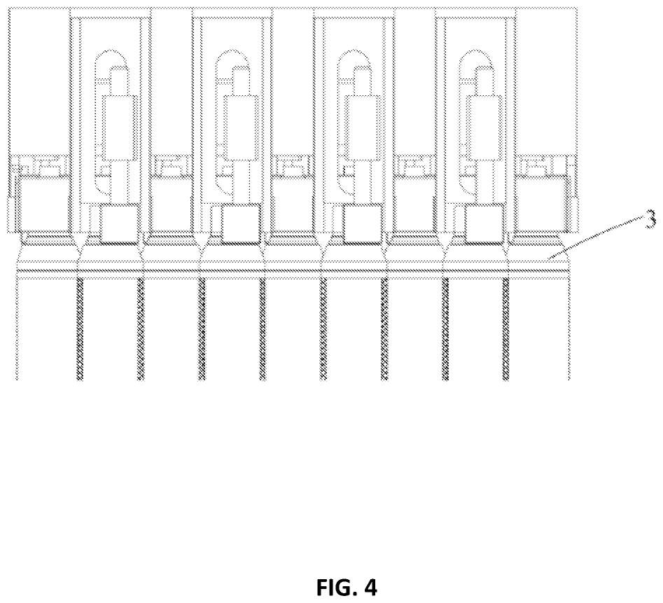

As an example, refer to FIG. 3 and FIG. 4, a plurality of galvanometer cutting modules 3 are arranged on both sides of the crossbeam through the mounting plate 4.

In the technical solution, the galvanometer cutting modules are directly fixed on the side of the crossbeam through the corresponding mounting plate, the galvanometer cutting modules are fixed and immovable, the material is arranged under the galvanometer cutting modules through a strip or sheet and the corresponding processing is completed. Then, the processing of the remaining areas is completed sequentially by moving the material.

As an example, refer to FIG. 3 and FIG. 4, the adjacent galvanometer cutting modules 3 on both sides of the crossbeam are staggered.

In the technical solution, the crossbeam is provided with five galvanometer cutting modules on the side close to the feeding side and four galvanometer cutting modules on the side close to the discharging side. Along the X-axis direction (the direction of material movement), the four galvanometer cutting modules on the discharging side are arranged between the adjacent galvanometer cutting modules on the feeding side, which are used to process the shadow area between the adjacent galvanometer cutting modules on the feeding side and complete the processing of the entire width direction with the movement of the material. Among them, the processing areas (dashed line) of the adjacent galvanometer cutting modules (located on both sides of the crossbeam, respectively) in the Y-axis direction are partially overlapped (section line), which facilitates the splicing of the cut seams. The galvanometer cutting modules on both sides can be positioned interchangeably. The gantry can be directly arranged on the stand of the production line. An ongoing roll-to-roll processing can be completed, namely, the corresponding processing can be completed uninterruptedly, without stopping the material or moving the galvanometer cutting modules, which improves the work efficiency.

As an example, the module further comprises an image detection system.

In the technical solution, the specific structure and principle of the image detection system can be a conventional image detection system. The image detection system can be used for real-time monitoring of patterns to be processed, which can improve the splicing accuracy of cut seams. It can be used in conjunction with an external manipulator to adjust the position of the pattern to be processed, such as translation or rotation, or in conjunction with an acoustic or visual alarm device to give alarms such as errors and offsets.

In summary, the large-format laser processing module is characterized by a simple structure and simultaneous processing by a plurality of galvanometer cutting modules, which improves production efficiency.

It should be noted that, as used herein, the terms “including”, “comprising”, or any other variant thereof, are intended to cover non-exclusive inclusion, such that a process, method, article, or apparatus comprising a set of elements includes not only those elements, but also other elements that are not expressly listed, or that are inherent to such process, method, article or apparatus. Without further limitation, an element defined by the statement “comprising a . . . ” does not preclude the existence of another identical element in the process, method, article, or apparatus comprising the element.

What is claimed is:

1. A large-format laser processing module, comprising:
galvanometer cutting modules arranged above a stand through a gantry;
the gantry comprises two support frames fixed to the stand and a crossbeam fixed to the top of the two support frames;
wherein the number of the galvanometer cutting modules is at least two and the galvanometer cutting modules are arranged on the same side or both sides of the crossbeam;
a mounting plate for mounting the galvanometer cutting modules is arranged on the same side or both sides of the crossbeam; and
one or more galvanometer cutting modules are arranged within the mounting plate.

2. A large-format laser processing module according to claim 1, wherein the mounting plate is slidably connected to one side of the crossbeam by a linear motor and a plurality of galvanometer cutting modules are arranged side by side within the mounting plate.

3. A large-format laser processing module according to claim 1, wherein both sides of the crossbeam are slidably connected to a mounting plate by a linear motor, respectively.

4. A large-format laser processing module according to claim 3, wherein one galvanometer cutting module is arranged within the mounting plate.

5. A large-format laser processing module according to claim 3, wherein a plurality of galvanometer cutting modules are arranged side by side within the mounting plate.

6. A large-format laser processing module according to claim 1, wherein a plurality of galvanometer cutting modules are arranged on both sides of the crossbeam through the mounting plate.

7. A large-format laser processing module according to claim 6, wherein the adjacent galvanometer cutting modules on both sides of the crossbeam are staggered.

8. A large-format laser processing module according to claim 1, further comprising:
an image detection system.
